(19) United States
(12) Patent Application Publication
(10) Pub. No.: US 2015/0089338 A1
(43) Pub. Date: Mar. 26, 2015

(54) SYSTEM AND METHODS FOR PROVIDING A NETWORK APPLICATION PROXY AGENT

(71) Applicant: Jenke Wu KUO, San Diego, CA (US)

(72) Inventor: Jenke Wu KUO, San Diego, CA (US)

(73) Assignee: SONY CORPORATION, Tokyo (JP)

(21) Appl. No.: 14/037,082

(22) Filed: Sep. 25, 2013

(51) Int. Cl. H04L 29/12; G06F 17/22

(52) U.S. Cl. CPC H04L 61/2528; G06F 17/2235
USPC 715/205

(57) ABSTRACT

A system and methods are provided for a network application proxy agent. In one embodiment, a method includes detecting a web page presented by a device, wherein the web page is detected by a network application proxy agent executed by the device, detecting one or more elements of the web page presented by the device, and accessing a configuration table to determine one or more proxy links for one or more detected elements of the web page presented by the device. The method may further include directing, by the network application proxy agent, presentation of the web page by the device based on one or more proxy links associated with the configuration table.

### FIELD

The present disclosure relates generally to network systems and methods, and more particularly to a device and methods for providing a network application proxy agent.

### BACKGROUND

Many websites typically include external links, links to other pages, pictures and media files. In many instances, links and objects of the web page may be sourced from another network location. In addition, it is quite common that links to a particular network location will be eliminated or changed from time to time. As such, many links will be broken, either temporarily or permanently, and elements of a webpage may lead to dead ends and in some cases may be unusable. For web application developers, bloggers and social network users, long term works or web page data may be lost. In many cases, it may be difficult to recreate or repair broken links. There is a need for maintaining website data to keep web page elements available and secure.

### BRIEF SUMMARY OF THE EMBODIMENTS

Disclosed and claimed herein are a device and methods for providing a network application proxy agent. In one embodiment, a method includes detecting a web page presented by a device, wherein the web page is detected by a network application proxy agent executed by the device, detecting one or more elements of the web page presented by the device, accessing a configuration table to determine one or more proxy links for one or more detected elements of the web page presented by the device, and directing, by the network application proxy agent, presentation of the web page by the device based on one or more proxy links associated with the configuration table. Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram for providing a network application proxy agent according to one or more embodiments;

FIG. 2 depicts a process for providing a network application proxy agent according to one or more embodiments;

FIG. 3 depicts a simplified block diagram of a device according to one embodiment;

FIG. 4 depicts a process according to one or more embodiments; and

FIG. 5 depicts a process according to one or more embodiments.

### DETAILED DESCRIPTION OF THE EXEMPLARY EMBODIMENTS

### Overview and Terminology

One aspect of the disclosure relates to a device and methods for providing a network application proxy agent. In one embodiment, a network application proxy agent is a network application (e.g., computer application, executable code, etc.) configured to detect one or more elements of a web page (e.g., web site, web page, internet address, network address, etc.) and direct presentation of the web page. In an exemplary embodiment, the network application proxy agent may cache web page data and direct presentation of the web page based on accessible web page data and data cached for the web page. By directing presentation of a web page to include cached data, the network application proxy agent can allow users to view data of web pages that may have changed or for which links have been deleted or broken.

According to one embodiment, a network application proxy agent may be configured as a web application itself. The network application proxy agent may be configured to conduct or activate as a network application using machine independent code. (e.g. HTML, JAVA). In that fashion, the network application proxy agent can be executed by any kind of network/web application engine (e.g., commercial browser, JVM (Java Virtual Machine), etc.).

As used herein, a network application proxy agent is a computer executable program which may be executed by a device and which communicates by way of a computer network with one or more devices or network entities.

According to one aspect of the disclosure, a network application proxy agent may be configured to allow for presentation of a website based on one or more proxy links. By way of example, many network applications, such as web browsers, personal communication applications, and social media applications allow for elements to be stored, presented, or linked to. The network application proxy agent can detect web page elements and cache data for the elements. One use of the network application proxy agent is to provide a personal cloud provision agent to redirect address information (e.g. url's) for images, data, and media to new locations when data of a website is moved, changed, or is unavailable either temporarily or permanently. Another use may be to provide a network application proxy agent implemented as a web application and provision server. The network application proxy agent may be configured to cache and/or backup URL page code, image data, pictures or media files periodically, and convert the links of web pages to the personal provision server as proxy to direct the links to be stored. Thus, as the stored server or web service changes, a browser doesn't need to change page code, but can change a configuration table to direct or backup to a new link or page. A configuration table can be for a single link or groups of links as by database management. The proxy agent can maintain and convert web page data to direct tables of links by a configuration tool or page implemented in the web application user interface. The network application proxy agent may be configured to detect and monitor whether elements of a web page, such as service links are eliminated or changed. The network application proxy agent may also repair, redirect or clone links to a new server/service that caches the page, data and media files immediately. In some cases, the network application proxy agent could involve a business relationship with the web page or real-time availability. Because many cloud services are not permanent, and pins (e.g., web links) of personnel interests in a web notebook may also need to repair and redirection, a network application proxy agent can cache these pages and data at a network location instead of requiring a user to manually backup links and data.

In one embodiment, a method for providing a network application proxy agent includes detecting one or more elements of the web page presented by the device, and generating a configuration table with proxy links for one or more detected elements of the web page. In that fashion, the configuration table may be accessed to determine one or more proxy links for web page elements.

According to another embodiment, an electronic device is provided, such as a consumer electronic device that may be configured to provide a network application proxy agent for one or more network applications. In another embodiment, a system is providing for a device to execute a network application proxy agent. The system may allow for a device to communicate with one or more other devices. Although the disclosure is described as relating to network applications, it should be appreciated that the devices and methods described herein may be employed for one or more additional benefits and uses.

In yet another embodiment, a computer program product is provided for monitoring and updating a network application across devices. The computer program product may be stored by non-transitory memory of a device and may be executed by the device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CI)-ROM, an optical disk, a hard disk, a non-transitory medium, etc.

### Exemplary Embodiments

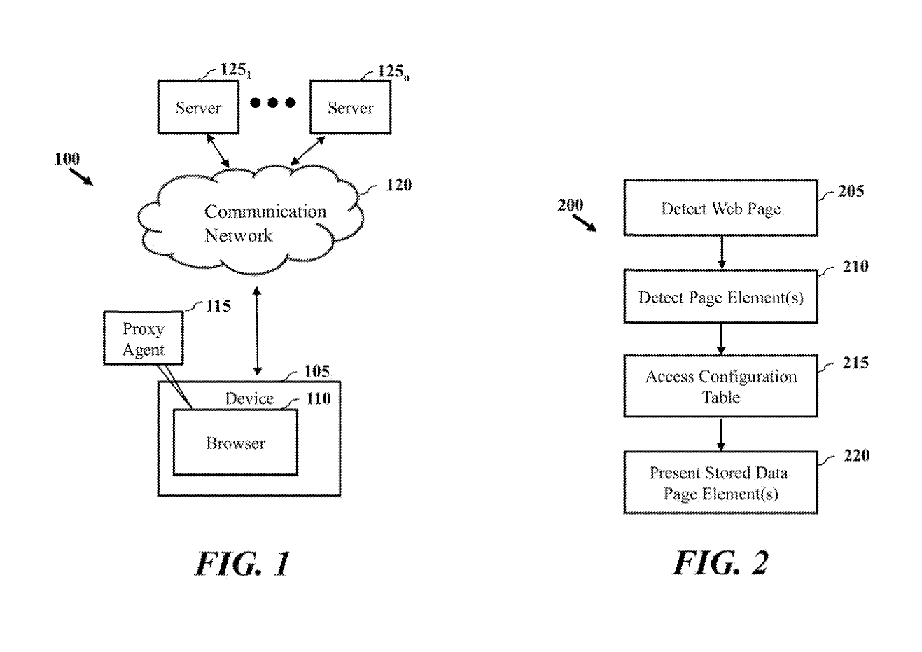

In one embodiment, a network application proxy agent may be configured to redirect presentation of one or more web pages, or network locations, of a network system. Redirection may be based on one or more proxy links stored in a configuration table of the network application proxy agent. Referring now to the figures, FIG. 1 depicts a simplified system diagram according to one or more embodiments. System 100 may be employed for providing a network application proxy agent. As shown in FIG. 1, system 100 includes device 105, communication network 120, and one or more servers, shown as servers 125₁₋ₙ. System 100 may support operation of one or more devices, such as device 105. According to one embodiment, device 105 may be configured to execute a browser application, shown as 110. According to another embodiment, browse application 110 may be configured to execute network application proxy agent 115 (identified as proxy agent in FIG. 1).

Network application proxy agent 115 may be executed by device 105 to cache network data and to direct one or more elements of a web page to a configuration table. According to one embodiment, network application proxy agent 115 may generate and access a configuration table for one or more proxy links to present a web page. According to another embodiment, network application proxy agent 115 may be implemented as a web application and is associated with a browser application 110 executed by device 105. In yet another embodiment, network application proxy agent 115 may be configured to monitor browsing of one or more web pages or browser cache. In certain embodiments, network application proxy agent 115 may store cached data locally. In other instances, network application proxy agent 115 may store cached data via one or more servers, such as servers 125₁₋ₙ. According to one embodiment, network application proxy agent 115 may executed by one or more types of devices. Device 105 may be an end user device, such as a consumer electronic device. Device 105 may relate to one or more device types, such as consumer electronic, personal, mobile, handheld, computer, media player, gaming system, gaming console, display devices, etc. Browser 110 may relate to one or more of types of applications, such as gaming applications, media players, user interfaces, display, network applications, etc.

Communication network 120 may allow for one or more of wired and wireless communication. For example, communication network 120 may allow for network based communications including, but not limited to, LAN, WAN, WI-FI, etc. Device 105 of FIG. 1 may be configured to connect to a server via communication network 120, which may include wired and/or wireless components. Servers 125₁₋ₙ may be configured to provide data associated with one or more web pages. Although system 100 is described above as having a single device, it may be appreciated that system include a plurality of devices.

According to one embodiment, network application proxy agent 115 may of system 100 may communicate via communication network 120 which may include wired and/or wireless communication. Communication among devices may be facilitated and/or involve communication with a server. In one embodiment, servers 125₁₋ₙ may relate to an application server to provide data for a network application.

Network application proxy agent 115 may be executed by device 105 for one or more web pages viewed by browser 110. In certain embodiments, network application proxy agent 115 is operating system independent, in that the proxy agent may be executed by a device independent of the operating system of code controlling the device. By way of example, network application proxy agent 115 may be code (e.g., HTML, Java, etc.) to be executed by a network/web application engine, such as a commercial browser or JVM Java virtual machine.

One benefit of network application proxy agent 115, as described herein, may be to allow for network applications to be synchronized across a plurality of devices.

Referring now to FIG. 2, a process is depicted for providing a network application proxy agent according to one or more embodiments. Process 200 of FIG. 2 may be executed by a device (e.g., device 105) to launch and execute a network application proxy agent. According to one embodiment, many network applications can be complimented with a network application proxy agent without changing the code across platforms.

Process 200 may be initiated by detecting a web page presented by a device at block 205. The web page may be detected at block 205 by a network application proxy agent executed by the device. Process 200 is described with respect to an end user device; however, it should be appreciated that other types of devices may execute the network application proxy agent. The network application proxy agent may be executed by a browser application. In certain embodiments, the network application proxy agent may be an operating system independent network application.

At block 210, one or more elements of a presented web page may be detected by the device. In one embodiment, the network application proxy agent can filter webpage data received by browser application to identify one or more of text, image data, audio data, hyperlink data, network address, web page documents and network information in general.

Process 200 may continue with accessing a configuration table to determine one or more proxy links for one or more detected elements of the web page presented by the device at block 215. The configuration table can include links detected in a webpage and one or more proxy links for data associated with detected elements of the web page. Accessing the identification table includes can include detecting data stored by at least one of a local device and a network location. Proxy links include storage locations for data of one or more of web page elements.

At block 215, process 200 includes directing, by the network application proxy agent, presentation of the web page by the device based on one or more proxy links associated with the configuration table. In one embodiment, directing includes presenting one or more web page elements by the device based on data retrieved from one or more proxy links.

As will be discussed in more detail below with respect to FIG. 4, the network application proxy agent may be configured to store data of webpage elements based on data cached by a web browser application. The network application proxy agent may be configured to detect broken links included in a web page and access the configuration table to determine one or more proxy links.

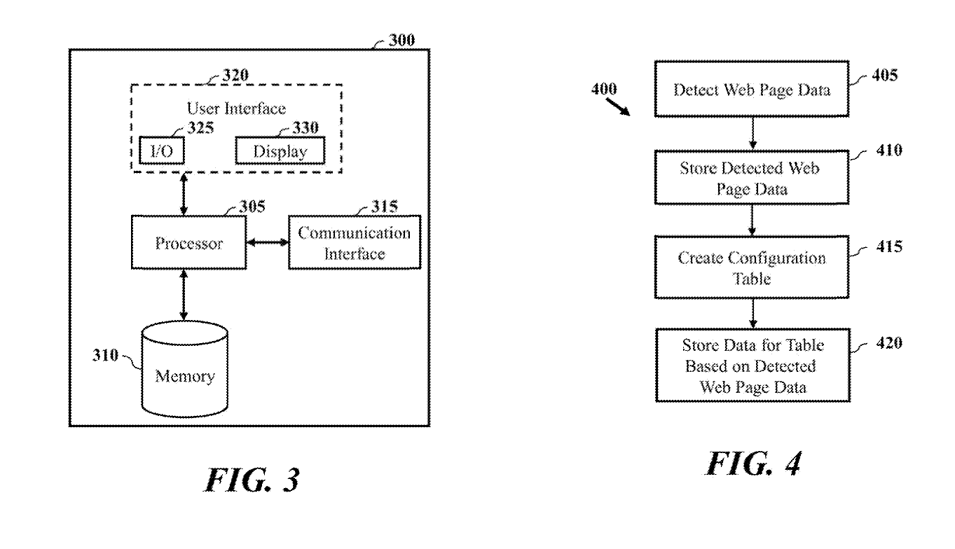

Referring now to FIG. 3, a simplified block diagram is depicted of a device according to one or more embodiments. Device 300 may relate to one or more of personal communication device, media player, imaging device, mobile electronic device, gaming device, gaming console, display device and consumer electronic device in general. Alternatively or in combination, device 300 may be one or more of a display device, set-top box, communication device, media player, gaming device or computing device in general. In certain embodiments, the device of FIG. 1 (e.g., device 105) may be configured similarly to device 300. Device 300 may be configured to execute one or more applications, including a browser application and a network application proxy agent. In certain embodiments, device 300 may be configured to allow for a network application proxy agent to direct operation of a browser application.

Device 300 includes processor 305, memory 310, and communication interface 315. Device 300 may optionally include user interface 320. User interface 320 may include an input/output (I/O) interface 325 and display 330. Elements of device 300 may be configured to communicate and interoperate with processor 305 by a communication bus. Processor 305 may be configured to control operation of device 300 based on one or more computer executable instructions stored in memory 310. In one embodiment, processor 305 may be configured to providing a network application proxy agent. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more audio and video files. According to another embodiment, memory 310 can store one or more computer readable instructions to allow for device 300 to perform the processes of FIGS. 2, 4 and 5.

Communication interface 315 may include one or more elements to allow for communication by device 300 by wired or wireless communication. Communication interface 315 may include one or more ports for receiving data, including ports for removable memory. Communication interface 315 may be configured to allow for network based communications including but not limited to LAN, WAN, Wi-Fi, etc.

According to one embodiment device 300 may optionally include user interface 320 to detect user commands and/or output data. As shown in FIG. 3, user interface 320 includes input/output (I/O) interface 325 configured to output data and/or commands to one or more output devices, and display 330. According to one embodiment, I/O interface 325 may be configured to receive one or more user commands. I/O interface 325 may include one or more buttons to control operation of device 300 including controlling selection of content for display and controlling operation of device 300. Input buttons of I/O interface 325 may include one or more buttons for user input, such as a such as a numerical keypad, volume control, menu controls, pointing device, track ball, mode selection buttons, and playback functionality (e.g., play, stop, pause, forward, reverse, slow motion, etc.). Input buttons of I/O interface 325 may include hard and soft buttons, wherein functionality of the soft buttons may be based on one or more applications running on device 300. In certain embodiments, device 300 may include display 330 to display image data, such as video data and graphics data, alert messages, and display one or more applications executed by processor 305.

According to one embodiment, a network application proxy agent may be configured to direct presentation of a web page based on one or more proxy links associated with a configuration table. FIG. 4 depicts a process for storing web page data by a providing a network application proxy agent according to one or more embodiments. In certain embodiments, process 400 may be employed to cache data of one or more web pages.

Process 400 may be initiated by detecting web page data at block 405. By way of example, the network application proxy agent may be configured to filter data that may be subject to change, such as links, image data etc. For particular web pages, such as social media, blogs, and online forums, the network application proxy agent may search for hyperlinks, URL data and image data which may be subject to change. Detected web page data may be stored at block 410. In certain embodiments the data may be stored locally, such as by a device. In other embodiments, the data may be cached to a network based storage source (e.g., server, cloud service, etc.).

Based on detected web page data, the network application proxy agent may create a configuration table at block 415. In one embodiment, the configuration table includes links and identifiers for elements detected in a web page. According to another embodiment, the configuration table may include one or more links to data stored at block 410. Process 400 may continue with storing data for a configuration table based on detected web page data at block 420. By detecting and storing data, a network application proxy agent may allow for data to be provided to a browser when links are broken or web page data is no longer available.

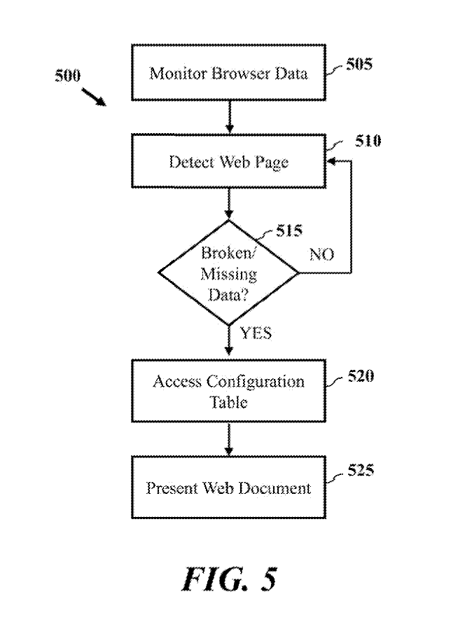

According to another embodiment, a network application proxy agent may be configured to direct presentation of a web page based on detection of broken links and/or missing data in a web page. Referring now to FIG. 5, a process is shown for presentation of a web document according to one or more embodiments. Process 500 may be performed by a device executing a network application proxy agent. Process 500 may be initiated by monitoring browser data at block 505. At block 510, a network application proxy agent executed by a device may detect web page data.

According to one embodiment, the network application proxy agent may be configured to search for broken links and/or missing data associated with the page at block 515. When broken links and/or missing data has been identified (e.g., “YES” block out of decision block 515), the network application proxy agent can proceed to block 520 and access a configuration table. When the network application proxy agent has not identified broken and/or missing data (e.g., “NO” block out of decision block 515), the network application proxy agent can continue detecting web page data at block 510. Based on the data accessed from the configuration table at block 520, the network application proxy agent can direct a browser application to present a web application at block 525.

While this disclosure has been particularly shown and described with references to exemplary embodiments thereof, it will be understood by those skilled in the art that various changes in form and details may be made therein without departing from the scope of the claimed embodiments.

What is claimed is:

1. A method for providing a network application proxy agent, the method comprising the acts of:
detecting a web page presented by a device, wherein the web page is detected by a network application proxy agent executed by the device;
detecting one or more elements of the web page presented by the device;
accessing a configuration table to determine one or more proxy links for one or more detected elements of the web page presented by the device; and
directing, by the network application proxy agent, presentation of the web page by the device based on one or more proxy links associated with the configuration table.

2. The method of claim 1, wherein the network application proxy agent is executed by a browser application.

3. The method of claim 1, wherein detecting includes filtering webpage data received by browser application.

4. The method of claim 1, wherein the network application proxy agent is an operating system independent network application.

5. The method of claim 1, wherein one or more elements of the web page is at least one of text, image data, audio data, hyperlink data, network address, web page documents and network information in general.

6. The method of claim 1, wherein the configuration table includes links detected in a webpage and one or more proxy links for data associated with detected elements of the web page.

7. The method of claim 1, wherein accessing the identification table includes detecting data stored by at least one of a local device and a network location.

8. The method of claim 1, wherein proxy links include storage locations for data of one or more of web page elements.

9. The method of claim 1, wherein directing includes presenting one or more web page elements by the device based on data retrieved from one or more proxy links.

10. The method of claim 1, further comprising storing data of webpage elements based on data cached by a web browser application.

11. The method of claim 1, further comprising detecting a broken link included in a web page and accessing the configuration table to determine one or more proxy links.

12. A device comprising:
a communication module,
a memory, and
a processor coupled to the sensor and the communication module, the processor configured to:
detect a web page presented by the device, wherein the web page is detected by a network application proxy agent executed by the device;
detect one or more elements of the web page presented by the device;
access a configuration table to determine one or more proxy links for one or more detected elements of the web page presented by the device; and
directing presentation of the web page by the device based on one or more proxy links associated with the configuration table.

13. The device of claim 12, wherein the network application proxy agent is executed by a browser application.

14. The device of claim 12, wherein detecting includes filtering webpage data received by browser application.

15. The device of claim 12, wherein the network application proxy agent is an operating system independent network application.

16. The device of claim 12, wherein one or more elements of the web page is at least one of text, image data, audio data, hyperlink data, network address, web page documents and network information in general.

17. The device of claim 12, wherein the configuration table includes links detected in a webpage and one or more proxy links for data associated with detected elements of the web page.

18. The device of claim 12, wherein accessing the identification table includes detecting data stored by at least one of a local device and a network location.

19. The device of claim 12, wherein proxy links include storage locations for data of one or more of web page elements.

20. The device of claim 12, wherein directing includes presenting one or more web page elements by the device based on data retrieved from one or more proxy links.

21. The device of claim 12, further comprising storing data of webpage elements based on data cached by a web browser application.

22. The device of claim 12, further comprising detecting a broken link included in a web page and accessing the configuration table to determine one or more proxy links.

23. A computer program product stored on computer readable medium including computer executable code for providing a network application proxy agent, the computer program product comprising:
computer readable code to detect a web page presented by a device, wherein the web page is detected by a network application proxy agent executed by the device;
computer readable code to detect one or more elements of the web page presented by the device;
computer readable code to access a configuration table to determine one or more proxy links for one or more detected elements of the web page presented by the device; and
computer readable code to direct, by the network application proxy agent, presentation of the web page by the device based on one or more proxy links associated with the configuration table.
